(19) United States
(12) Patent Application Publication
(10) Pub. No.: US 2013/0103767 A1
(43) Pub. Date: Apr. 25, 2013

(54) RETURN NOTIFICATIONS OF TASKS PERFORMED WITH ENTITIES

(71) Applicants: John Carey, Sammamish, WA (US); Okalo Daniel Ikhena, Seattle, WA (US)

(72) Inventors: John Carey, Sammamish, WA (US); Okalo Daniel Ikhena, Seattle, WA (US)

(73) Assignee: MICROSOFT CORPORATION, Redmond, WA (US)

(21) Appl. No.: 13/278,794

(22) Filed: Oct. 21, 2011

(51) Int. Cl. G06F 15/16

(52) U.S. Cl. 709/206

(57) ABSTRACT

Feedback is provided to sources of information entities regarding subsequent utilization of those entities, thereby providing a measure of control through feedback loops that can include incentives or disincentives for specific tasks performed on entities, or tasks performed by specific services. An entity source, including intermediate sources and original authors of a cohesive collection of information that is an “entity”, provide those entities together with a return message template and an interface to which a return message is to be directed when a subsequent task is performed on that entity. Intermediate services, such as user agents, can add their own return message templates and interfaces to which return messages are to be directed. Subsequent performance of tasks on those entities comprises the creation and transmission of return messages to the interfaces specified and transmitted with the entity, thereby enabling prior systems to maintain logs of the utilization of an entity.

### BACKGROUND

As networks of computing devices expand, a greater quantity of information is made available through network communications and a greater quantity of services are developed to receive such information and perform actions with it. Typically, the information that is made available via network communications is provided in a one-way manner, where the recipients of information can utilize that information without further notification to the source of the information. For example, an airline or hotel operator can make available, through computer network communications, information regarding that airline's flights or that hotel's properties. Such information can then be received by network-based services that can further utilize such information. For example, a networked travel service can enable users to add such information to a travel itinerary that it can generate and maintain, a networked social media service can enable users to notify other users of such airline or hotel information, and a networked advertising service can reformat such airline or hotel information such that it can be displayed on digital billboards or other like digital advertisements.

However, in each of the above examples, the source of the information, such as the airline or the hotel operator, would remain ignorant as to the use of its airline or hotel information. For example, if a user were to utilize a networked travel service to add some of this airline information to their itinerary, the networked travel service could obtain the airline information from the airline operator, but such a network travel service would not let the airline operator know how that particular set of airline information was utilized. Similarly, as another example, if a user were to utilize a networked social media service to communicate hotel information to other users, such a networked social media service could obtain the hotel information from the hotel operator, but would not let the hotel operator know the manner in which the obtained hotel information was utilized. The lack of such feedback denies information authors, or information sources, a measure of control that could be utilized to the benefit of either or both of the information authors and the information consumers, including end-users.

### SUMMARY

In one embodiment, to provide information authors and intermediate information sources feedback regarding subsequent utilization of their information, a return message template and an interface to which a return message, formatted in accordance with the return message template, is to be sent can be provided with an “entity” or cohesive collection of information. Subsequent utilization of that entity can require the transmission of a return message to the interface specified.

In another embodiment, intermediate systems utilizing an entity can themselves add their own return message templates and their own interfaces to which a return message, formatted in accordance with the return message template, is to be sent. Further, downstream, utilization of such an entity can require not only the transmission of a return message to the interface specified by the entity author, or source, but can also require the transmission of a return message to the intermediate systems, via the interface specified by those intermediate systems.

In a further embodiment, the receipt of a return message indicating utilization of an entity can be stored, as can a system's own utilization of that entity, thereby providing a log of the utilization of an entity across a range of systems.

In a still further embodiment, the provided feedback, in the form of return messages, can enable the provision of incentives to incentivize certain utilizations of entities, and, analogously, de-incentivize other utilizations of entities.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary registration of interfaces;

FIG. 2 is a block diagram of an exemplary provision of an entity;

FIG. 3 is a block diagram of another exemplary provision of an entity;

FIG. 4 is a block diagram of an exemplary downstream provision of an entity;

FIG. 5 is a block diagram of an exemplary provision of return messages;

FIG. 6 is a flow diagram of an exemplary sourcing of entities;

FIG. 7 is a flow diagram of an exemplary intermediate utilization of entities;

FIG. 8 is a flow diagram of an exemplary utilization of entities; and

FIG. 9 is a block diagram of an exemplary computing device.

### DETAILED DESCRIPTION

The following description relates to mechanisms for enabling feedback to sources of information entities regarding subsequent utilization of those entities. An entity source, including both intermediate sources, and the original author of a cohesive collection of information that is an “entity”, can provide, together with the entities themselves, a return message template and an interface to which a return message is to be directed when the entity is subsequently utilized, or when a subsequent task is performed on that entity. Intermediate services, such as user agents, can themselves add their own return message templates and interfaces to which return messages are to be directed. Subsequent utilization of those entities, such as when a subsequent task is performed on that entity, can comprise the creation and transmission of return messages to the interfaces specified along with the entity. The entity source, as well as intermediate systems, can, thereby, maintain a log of the utilization of an entity. Additionally, such feedback enables the provision of incentives to incentivize certain utilizations of entities, and certain tasks performed on those entities, and to also, analogously, de-incentivize other utilizations of entities and other tasks performed on those entities.

For purposes of illustration, the techniques described herein make reference to existing and known networking infrastructure, such as the ubiquitous Internet and World Wide Web (WWW). Also for purposes of illustration, the techniques described herein make reference to existing and known protocols and languages, such as the ubiquitous HyperText Transfer Protocol (HTTP) and the equally ubiquitous HyperText Markup Language (HTML). Such references, however, are strictly exemplary and are not intended to limit the mechanisms described to the specific examples provided.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

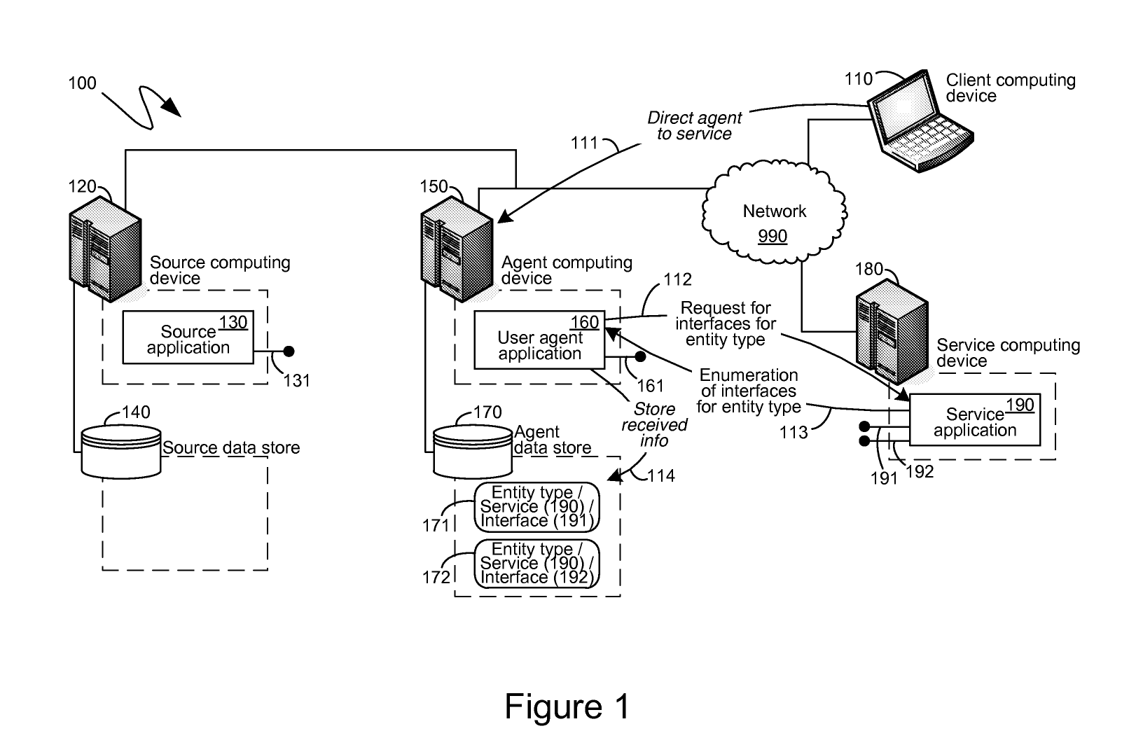

Turning to FIG. 1, an exemplary system 100 is shown, comprising a client computing device 110, three server computing devices, namely the server computing devices 120, 150 and 180, and a network 990 enabling communications between two or more of the client computing device 110 and the server computing devices 120, 150 and 180. Although illustrated as separate server computing devices 120, 150 and 180, the mechanisms described herein are equally applicable to independent processes executing on a single server computing device, or for configurations in which components or applications illustrated as executing on one server computing device are split among multiple servers. The mechanisms described herein are also applicable to virtualized server computing devices, such as can be created by one or more processes executing on either a single physical computing device or across multiple physical computing devices. Server computing devices 120, 150 and 180, therefore, are meant to represent not just physical server computing devices, but also virtualized server computing devices, or any other like independent executing processes. The system 100 of FIG. 1 further illustrates data stores 140 and 170 that are communicationally coupled to the server computing devices 120 and 150, respectively. As in the case of the server computing devices, the data stores 140 and 170 can be implemented by storage devices co-located with the server computing devices to which such data stores are illustrated as being communicationally coupled, or they could be implemented by remote storage devices through a virtualized storage scheme. As such, the data stores 140 and 170 are meant to represent not just physical storage devices co-located within the server computing devices to which they are illustrated as being communicationally coupled, but also remote and virtualized storage capabilities that can be utilized by processes executing on the server computing devices with which such data stores are illustrated as being communicationally coupled.

The server computing devices 120, 150 and 180 of the system 100 of FIG. 1 are nominated the “source computing device”, the “agent computing device” and the “service computing device”, respectively, in reference to the functionality that they provide within the context of the system 100 of FIG. 1. In particular, the source computing device 120 can have executing thereon a source application 130 that can provide entities within the context of the system 100 of FIG. 1. As such, the source application 130 can be either an original author of the entity or can be a subsequent provider of an entity that was authored by a further, upstream, process. Similarly, the agent computing device 150 can have executing thereon a user agent application 160 that can provide functionality to a user in regards to entities, such as the entities sourced by the source application 130. For example, the user agent application 160 can represent the functionality provided by many modern “portal” websites, including search functionality, calendaring functionality, digital lifestyle management functionality and the like. Within the context of the system 100 of FIG. 1, the user agent application 160 can interact with the user via a communicational connection between the agent computing device 150 upon which such a user agent application 160 can be executing and a client computing device 110 that can be utilized by a user. For example, the client computing device 110 can execute a ubiquitous Web browser that can enable a user of the client computing device 110 to interact with the user agent application 160 to a web interface provided by such a user agent application. Again, as indicated previously, such a web-based context is merely exemplary, as the mechanisms described herein are not limited to implementations relying upon the protocols and languages of the World Wide Web (“WWW”). Analogously to the source application 130 and the user agent application 160, the service application 190 can execute on the service computing device 180 and can provide functionality, with respect to entities, that can be utilized by a user, such as via the user agent application 160. For purposes of the descriptions herein, the term “entity” means a cohesive collection of information in digital form such as could be read and understood by computer-executable instructions executing on a computing device.

In one embodiment, as illustrated by the system 100 of FIG. 1, the user agent application 160 can comprise registration functionality by which the user agent application 160 can learn of functionality of one or more service applications, such as the service application 190, that can be exposed to the user. The registration functionality of the user agent application 160 can be “ad hoc” in the sense that the user agent application 160 can simply go out and, in a transient manner, learn of functionality that is currently available. Alternatively, the registration functionality of the user application 160 can be more persistent, such that learned functionality can be retained for future utilization. Additionally, such registration functionality can be performed on behalf of the user, including automatically, such that the user is not even aware of it, or it can be performed at the user's direction. In the latter case, the registration functionality of the user agent application 160 can be selective in the sense that it registers functionality identified by the user, or functionality to which the user directs the user agent application 160. For purposes of illustration, it is this latter exemplary embodiment that is illustrated by the system 100 of FIG. 1, where a user of the user agent application 160 directs the user agent application 160 to the service application 190, executing on the service computing device 180, such as by transmitting the user's instructions over the network 990 from the client computing device 110 to the agent computing device 150, as illustrated by the instruction message 111.

The user agent application 160 can, as illustrated by the communication 112, establish communications with the service application 190, which is executing on the service computing device 180, and can request that the service application 190 provide to it a listing of one or more interfaces of the service application 190 through which it can be utilized to perform tasks on specific types of entities, such as those types of entities that are identified by the user agent application 160 via the communication 112. In response to the communication 112, the service application 190 can enumerate those interfaces that are applicable to the types of entities identified by the user agent application 160, via the communication 112, and which are provided by the service application 190 in order to provide access to the functionality offered by the service application 190. In the exemplary embodiment illustrated by the system 100 of FIG. 1, the service application 190 can enumerate the interfaces 191 and 192, via the communication 113 that the service application 190 returns to the user agent application 160. To provide context, as one example, if the entity type specified by the user agent application 160, via the communication 112, was a travel entity type, such as, for example an airline entity or hotel entity, then the interfaces 191 and 192 that are enumerated by the service application 190, via the communication 113, can be interfaces through which the service application 190 can be instructed to perform actions such as, for example, adding information from the airline entity or the hotel entity to a user's itinerary, changing a seat or a room booking that is associated with the airline entity or the hotel entity, or canceling the airline entity or hotel entity and removing it from the user's itinerary.

In one embodiment, when the user agent application 160 learns of interfaces, such as the interfaces 191 and 192, that were provided to it by the service application 190, via the communication 113, the user agent application 160 can store such information into an agent data store 170, as illustrated by the action 114. For example, the user agent application 160 can store an association between the type of entity, the specific service, and the specific interface in the agent data store 170. In the exemplary system 100 of FIG. 1, two such associations are stored, namely the association 171 between a specific type of entity, the service 190 and the interface 191, and the association 172 between the same type of entity, the same service 190 and the other interface 192. As will be described in further detail below, the associations between entity types, available services, and available interfaces of those services can be referenced by the user agent application 160 to provide differing options to a user regarding an obtained entity.

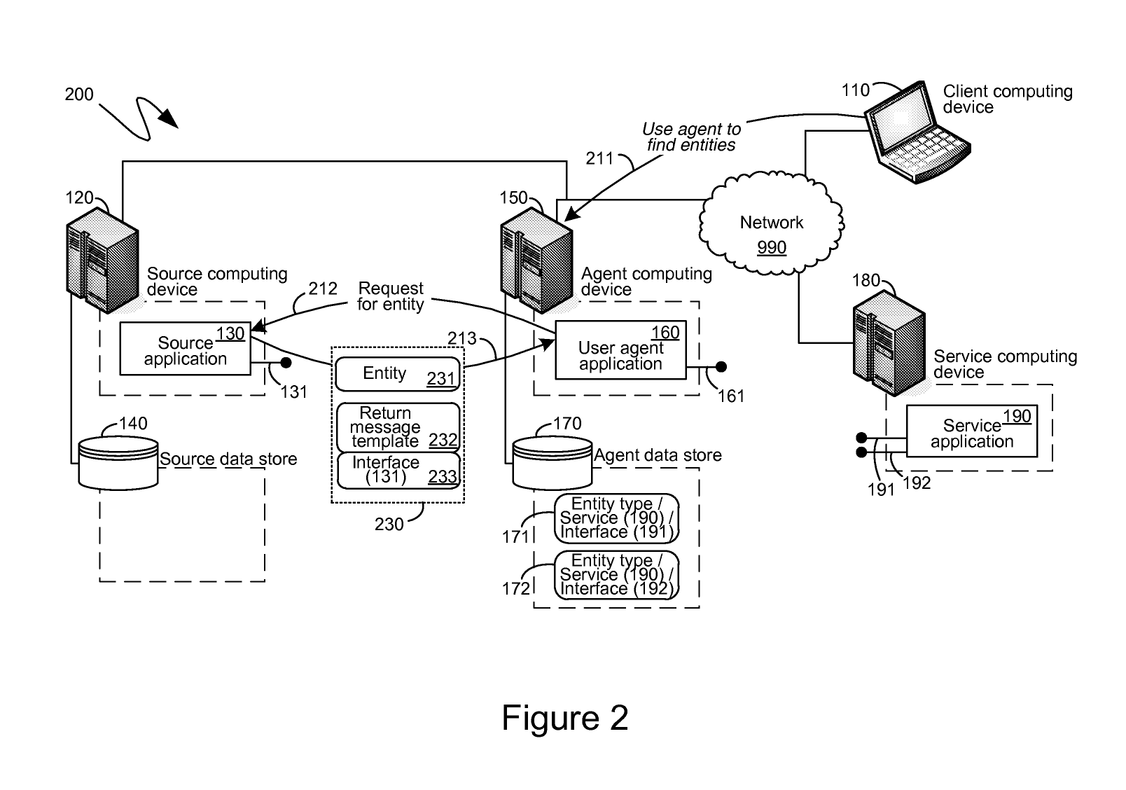

Turning to FIG. 2, the system 200 shown therein illustrates an exemplary obtaining of an entity from a source, such as the source application 130. In the specific example illustrated by the system 200 of FIG. 2, a user can instruct the user agent application 160 to obtain an entity from the source application 130. For example, the instruction 211, provided by the user, using the client computing device 110, to the user agent application 160, as executing on the agent computing device 150, can be a search query that can be utilized by the user agent application 160 to search for responsive entities available via the network 990. In such an example, the user agent application 160 can reference a search engine database or similar construct to initially identify source computing devices, such as the source computing device 120 that can provide entities that are responsive to the user's query. The search results can be provided to a user, who can select one or more search results, thereby prompting the user agent application 160 to issue the communication 212, to a source application 130, requesting an entity selected by the user. In response, the source application 130 can provide, such as via the communication 213, a package 230 that can comprise an entity 231, as well as a return message template 232 and the specification of an interface 233, such as the interface 131 that is exposed by the source application 130. To provide context, in one specific example, the entity 231 can be an airplane entity that can provide information about a specific flight offered by a specific airline, such as an airline that would operate the source computing device 120, or that would provide information to a source computing device 120, which could, in turn, be part of an airfare search service. As another example, again to provide context, the entity 231 can be a hotel entity that can provide specific information about room availability at a specific property that is part of the hotel chain, such as a hotel chain that would operate the source computing device 120, or that would provide information to a source computing device 120, which, in turn, could be part of a hotel search service. Thus, as can be seen, the source computing device 120 and the source application 130 need not be the original authors of the entity 231, but can, nevertheless, for the specific example illustrated by the system 200 of FIG. 2, act as the source of that entity.

In one embodiment, the return message template 232 can comprise an informational template specifying the type of information that is to be provided via a return message, as well as the manner in which that information is to be formatted. The return message template 232 can specify whether the requested information is required, or merely optional, and can provide for the formatting of additional information not specifically enumerated by the template. Associated with the return message template 232, and specified therewith, can be an interface specification 233 of an interface to which the return message, conforming to the return message template 232, can be directed. For example, in the example illustrated by the system 200 of FIG. 2, the interface specification 233 can specify the interface 131 of the source application 130 that can be configured to enable the source application 130 to receive return messages providing information regarding subsequent usages of the entity 231, including, for example, the performance of subsequent tasks using the entity 231. While, in the example illustrated by the system 200 of FIG. 2, the interface specification 233, which is provided with the entity 231, specifies an interface 131 of the source application 130, the interface specified by the interface specification 233 need not be an interface of the same application that provided the entity 231, such as the source application 130. Instead, in one embodiment, the source application 130 can provide the entity 231 with a package 230 in which the interface specification 233 specifies an interface that is provided by a different application than the source application 130 including, for example, a different application executing on the same source computing device 120, or a different application executing on a different computing device.

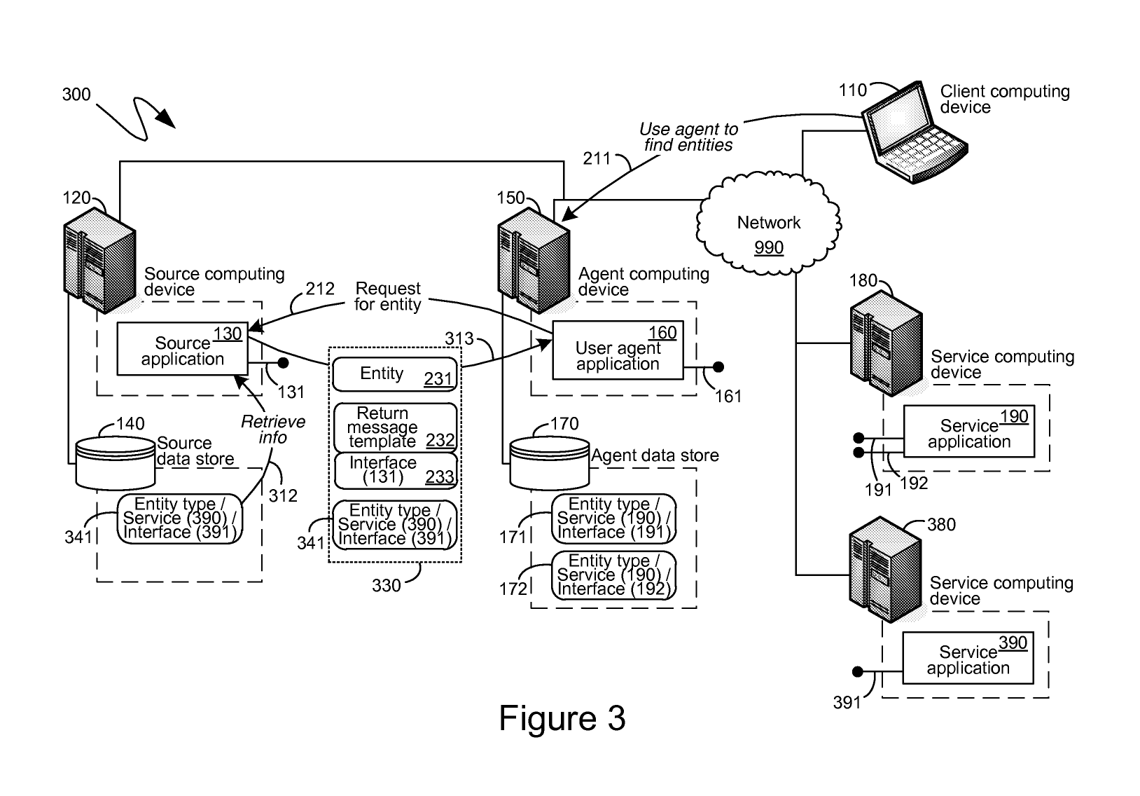

Turning to FIG. 3, the system 300 shown therein illustrates an alternative embodiment in which the source application 130 can provide a package 330 that comprises not only the entity 231, the return message template 232 and the interface specification 233, but can also provide an association 341, which the source application 130 knows of, and which can be useful for the entity 231. For example, as illustrated by the system 300 of FIG. 3, the source application 130 can have access to the source data store 140, which can comprise an association 341 between an entity type, a service application 390 executing on another service computing device 380 and a specific interface 391 provided by that service application 390, where the entity 231 is of the same type as the entity type indicated by the association 341. In one embodiment, the source application 130 can have learned of the service application 390, and of the specific interface 391 exposed by that service application, via analogous mechanisms to those described above with reference the system 100 of FIG. 1 and the communications between the user agent application 160 and the service application 190 that were illustrated therein.

In such an alternative embodiment, the source application 130, upon receiving the communication 212 requesting the entity 231, can retrieve the association 341 from the source data store 140, as illustrated by the action 312. Subsequently, the source application 130 can provide the package 330, comprising the entity 231, the return message template 232 and interface specification 233, as well as the association 341, to the user agent application 160, via the communication 313.

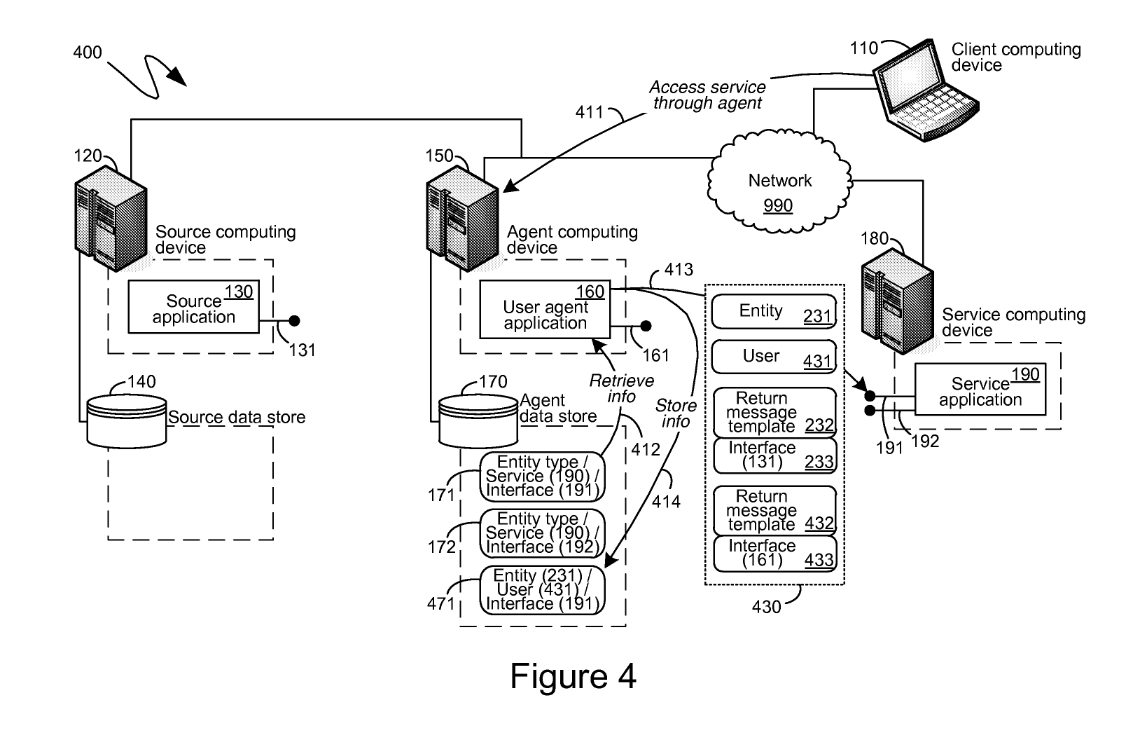

Turning to FIG. 4, the system 400 shown therein illustrates an exemplary utilization of the entity 231, which the user agent application 160 received from the source application 130. In one embodiment, a user of the user agent application 160 can instruct the user agent application 160 to invoke one of the known interfaces 191 and 192 of the service application 190 to have the service application 190 perform one or more tasks with respect to the entity 231 on behalf of the user. For example, the user agent application 160 can present to the user, such as through communications between the agent computing device 150 and the client computing device 110, via the network 990, options to utilize the interfaces of the service application 190, such as the interfaces 191 and 192. As indicated previously, the user agent application 160 can have discovered the interfaces 191 and 192 and can, upon receiving the entity 231 from the source application 130, reference the agent data store 170 to identify those associations that specify an entity type that is the same as that of the entity 231 that was received. In the example illustrated by the system 400 of FIG. 4, the associations 171 and 172, specifying the interfaces 191 and 192, respectively, of the service application 190, can be retrieved by the user agent application 160, as illustrated by the action 412, and the user agent application 160 can, thereby, generate a listing of options, including the options provided by those interfaces, that can be presented to the user, such as via the above indicated communications. In response, the user can instruct the user agent application 160 to have the service application 190 perform one or more of those tasks that are accessed via the interfaces 191 or 192. Thus, as shown by the system 400 of FIG. 4, the user can provide, to the user agent application 160, an instruction 411 that the user agent application 160 utilize one of the interfaces of the service application 190, such as, for example, the interface 191, to have the service application 190 perform a task relative to the entity 231 that was received from the source application 130.

In response to the instruction 411, the user agent application 160 can generate a package 430 that can be transmitted to the service application 190, and, more specifically, to the interface 191 of the service application 190 through which specific functionality of the service application 190, with respect to the entity 231, is being invoked. Such a package 430 can comprise the entity 231, as well as the return message template 232 and the interface specification 233 that were previously provided the source application 130. In addition, the package 430 can further comprise, in one embodiment, a specification of the user that is invoking that functionality, such as the user specification 431. Also in addition, the package 430 can further comprise, in one embodiment, a return message template 432 that is to be utilized to generate return messages to an interface that is specified, not by the source application 130, but by the user agent application 160. Like the return message template 232 that was described previously, the return message template 432 can, likewise, include specifications of whether particular requested information is required, or merely optional, and can provide for the formatting of additional information not specifically enumerated by the template. The interface specification 433 can specify an interface to which a return message can be directed after subsequent utilization of the entity 231, such as by performing a task with it. As before, the interface specification 433 need not specify an interface of the application that added that interface specification 433 to the package 430, in this case the user agent 160, although, in the specific example illustrated in FIG. 4 the interface specification 433 can specify the interface 161 of the user agent application 160.

The package 430 can be provided to an interface of the service application 190, such as interface 191, as illustrated by the communication 413. Additionally, in one embodiment, the user agent application 160 can store information in the agent data store 170, as illustrated by the action 414, which can record the presentation of the entity 231, to the interface 191 on behalf of the user 431. Such an entry 471 is illustrated in FIG. 4.

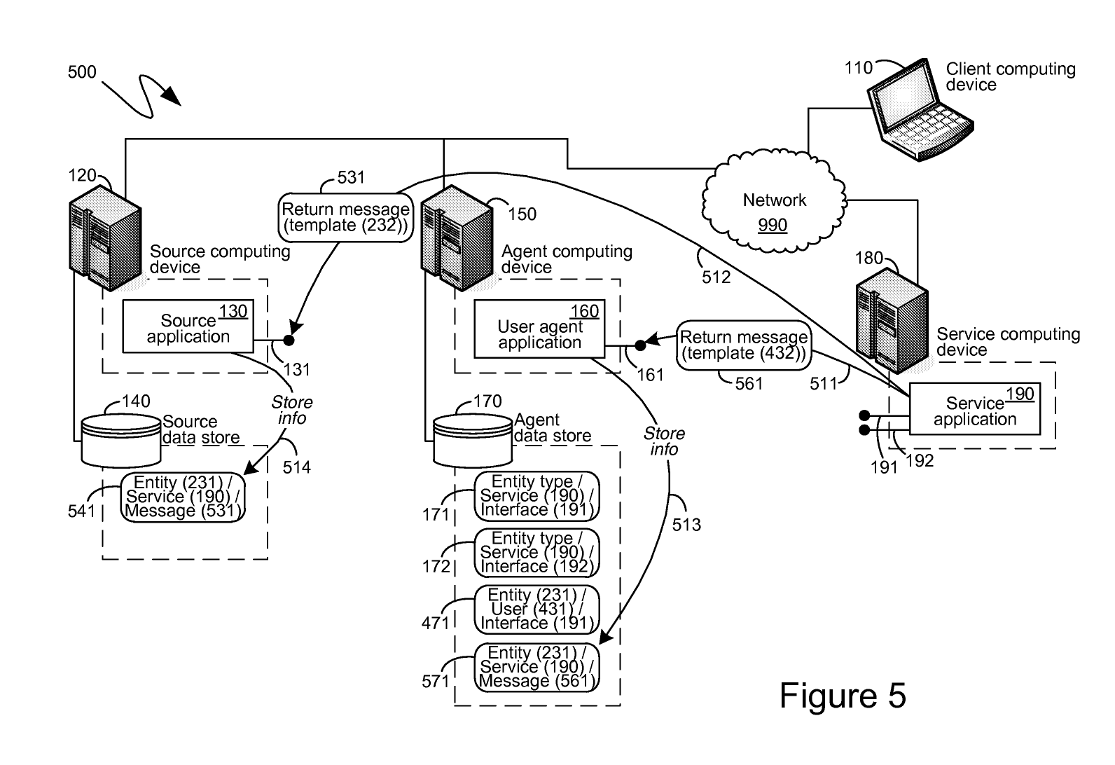

Turning to FIG. 5, the system 500 shown therein illustrates an exemplary operation of the service application 190 in providing return messages in accordance with the package 430, comprising the entity 231, that it was provided, such as in the manner shown in FIG. 4. Although not specifically illustrated, the service application 190 can perform the task, which it exposes via the interface 191, on the entity 231 that was provided via that interface in the manner shown in FIG. 4. For example, the interface 191 can expose the functionality of the service application 190 to add an entity to a user's itinerary. Thus, in such an example, if the entity 231 that was provided was an entity identifying a particular airline flight, then the service application 190 can add that airline flight to the user's itinerary in accordance with the functionality that was exposed by the called interface. Similarly, if the interface 191 exposed the functionality of the service application 190 to cancel a user's reservation, and if the entity 231 that was provided was an entity identifying a particular hotel, then the service application 190 can perform a task on that entity 231 in the form of canceling a user's reservation at the hotel identified by that entity.

In addition to performing the task on the entity that was provided to it, the service application 190 can also generate return messages and direct them to the interfaces identified by the package 430, shown in FIG. 4. Thus, for example, as illustrated via the communication 511, the service application 190 can generate a return message 561, in accordance with the template 432 that was shown in FIG. 4, and can provide such a return message to the interface 161 of the user agent application 160, which can be the interface that was specified by the interface specification 433, which was also shown in FIG. 4. Similarly, as also illustrated, the service application 190 can, via the communication 512, provide a return message 531 to the interface 131 of the source application 130. The return message 531 can be formatted in accordance with the template 232, that was shown in FIG. 4, and can be provided to the interface 131 that was specified by the interface specification 233, that was also shown in FIG. 4. In one embodiment, the return messages generated by the service application 190, such as the return messages 531 and 561, can conform to the templates specified such that they comprise the information requested by those templates which can be requested in a standardized manner such that independently implemented applications, such as the service application 190, can decipher those templates and recognize the information that is asked for and the formatting within which such information is to be provided. In another embodiment, the return messages generated by an application, such as the service application 190, need to be nothing more then indications that the service application 190 has, in fact, received the entity 231, shown in FIG. 4, and has performed a specific action on it. In such another embodiment, the return messages, such as the messages 531 and 561, may not necessarily conform to the templates specified but can, nevertheless, be received by the interfaces to which they are directed and logged in a meaningful way. In a further embodiment, if the service application 190 can understand the templates specifying the formatting of the return messages, but is not designed to provide, or acquire, the information requested, the return messages, such as the return messages 531 and 561, can comprise environmental variables that should be available to most any application including, for example, a date and time stamp, a network address, such as a network address of the service computing device 180, and other like environmental variables.

In one embodiment, when return messages, such as the return messages 531 and 561 are received at the interfaces specified, such as the interfaces 131 and 161, respectively, the applications exposing those interfaces can log the information provided via those return messages. Thus, as illustrated by the system 500 of FIG. 5, upon receiving the return message 561, via the interface 161, the user agent application 160 can store the information provided via the return message 561 into the agent data store 170, in the form of the log entry 571, as illustrated by the action 513. In one embodiment, the log entry 571 can comprise an identification of the entity 231 to which it is directed, the service application 190 from which the return message 561 was received, and the data provided via the return message 561 including, for example, a wholesale inclusion of the return message 561 itself. Similarly, upon receiving the return message 531 via the interface 131 the source application 130 exposed for such purpose, the source application 130 can log the information provided via the return message 531 in the source data store 140, such as is illustrated by the log entry 541 shown in the system 500 of FIG. 5. As with the log entry 571 described previously, the log entry 541 can comprise an indication of the entity 231 to which it is directed, the service application 190 from which the return message 531 was received, and the data provided via the return message 531.

In such a manner, authors and sources of entities can track the utilization of those entities, within a networked environment, by further, downstream applications or services. In the specific example illustrated by the system 500 of FIG. 5, the source application 130 can track the utilization of the entity 231 by further, downstream, applications, such as the service application 190. Such feedback can provide for a measure of control that can be exerted by entity offers or sources, such as the source application 130. For example, the mechanisms described above enable the source, or author, of an entity to receive the verification of the performance, or lack of performance, of one or more tasks on such an entity. Such feedback information can then be utilized to provide incentives, or disincentives, for particular types of tasks. For purposes of illustration, as an example, a specific entity author, such as an airline that authors entities comprising information regarding specific flights of that airline can offer incentives to network-based travel services to incentivize those travel services to provide users with access to unique functionality relevant only to that specific airline. In such an example, the source application 130 can learn of the performance, such as by the service application 190, of one or more tasks that such an airline may seek to incentivize. Consequently, upon receiving a return message, such as the return message 531, the source application 130 can determine if the return message 531 indicates the performance of a desired task and can, if the return message 531 so indicates, cause an appropriate positive incentive, such as a monetary payment, to be directed to the service application 190. As will be recognized by those skilled in the art, by incentivizing certain tasks, other tasks can be disincentivized merely by not having incentives associated with them. Alternatively, in another embodiment, active disincentives can be utilized, such as monetary penalties. In such a manner, the sources, or authors, of entities can exert a measure of control over the subsequent utilizations of those entities within a networked environment.

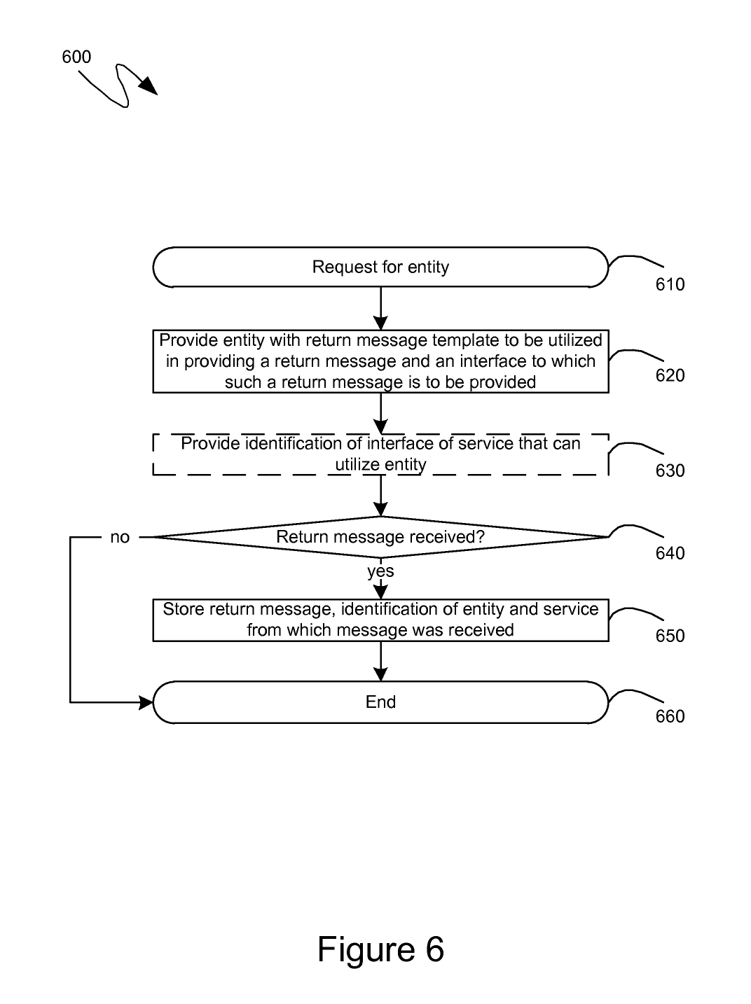

Turning to FIG. 6, the flow diagram 600 shown therein illustrates an exemplary series of steps that can be performed by an entity source, including an entity author. Initially, as illustrated by the step 610, the entity source can receive a request for one of its entities. In response, at step 620, the requested entity can be provided together with a return message template, such as that described in detail above, and an interface to which such a return message is to be provided. Optionally, at step 630, which is illustrated with dashed lines to indicate its optional nature, the response to the request, at step 610, can further comprise the identification of at least one interface of a service that can utilize, or perform a task, the entity provided at step 620. Subsequently, if a return message is received, as determined at step 640, the information from that return message can be stored, at step 650, thereby wanting the subsequent utilization of the entity provided at step 620. As described above, and as illustrated by step 650, the return message can include an identification of the entity upon which a task was performed and the service that performed that task, from which such a return message would have been received. Such information can be logged, at step 650, together with the return message itself and an indication of what task was performed by that service. The relevant processing can then end at step 660. In such a manner, entity sources, including original entity authors, can have a log that can be referenced as a basis for, for example, providing subsequent incentives, or disincentives, to further incentivize, or de-incentivize, specific behavior and the performance of specific tasks on an entity.

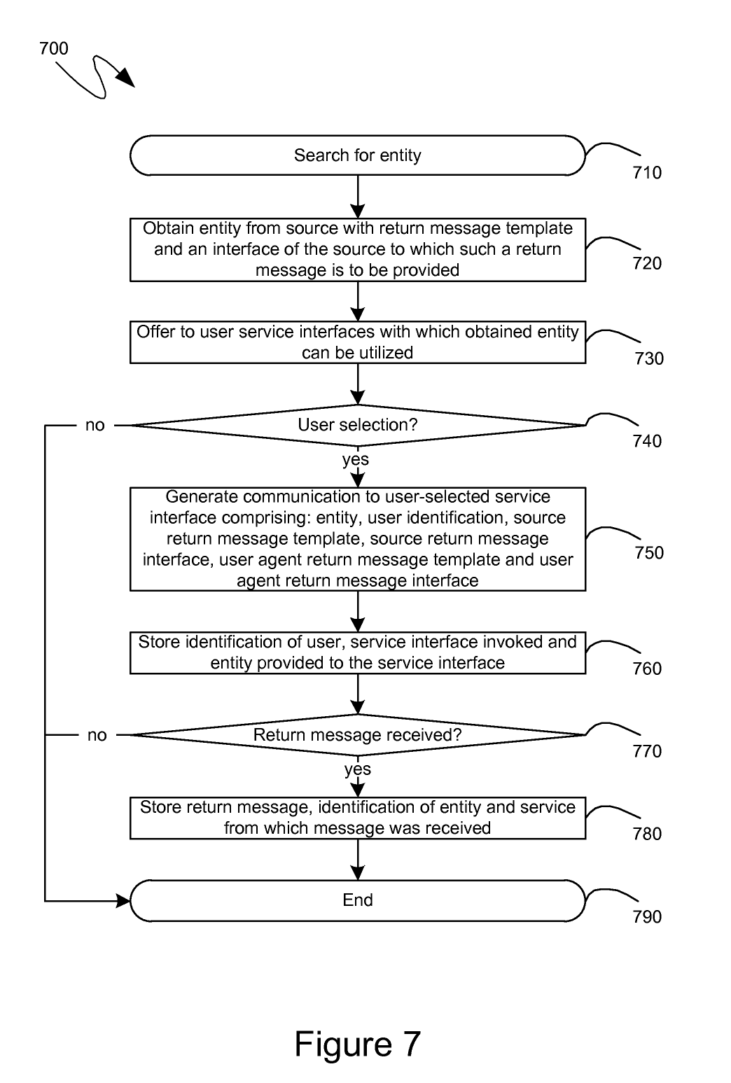

Turning to FIG. 7, the flow diagram 700 shown therein illustrates an exemplary series of steps that can be performed by an intermediate process that can receive entities from entity sources, and then pass those entities along to services that can perform tasks on those entities, such as on behalf of, or at the direction of, a user. Initially, at step 710, the user can initiate a search for an entity or can otherwise direct such an intermediate process to acquire an entity. Subsequently at step 720 the intermediate process can, in response to the user's directions at step 710, obtain an entity from a source. The obtaining of the entity, at step 720, can also include the obtaining of a return message template and an interface to which a return message is to be directed, as specified by the source from which the entity was received. At step 730, the user can be offered one or more tasks that can be performed on the obtained entity. As explained above, such tasks can be accessed through interfaces offered by services that can perform those tasks on entities. In one embodiment, at step 730, the user can be offered to perform tasks that are already known to the intermediate process, such as, for example, tasks that can be accessed through interfaces that were discovered previously through the registration process. Alternatively, at step 730, the user can direct the intermediate process to search for specific tasks either by directing the intermediate process to search for available interfaces, offer to buy specific services or, alternatively, to simply search for any available interfaces through which tasks applicable to the entity that was obtained at step 720 can be accessed.

Once the user has made a selection, as determined at step 740, the intermediate process can generate a communication through which the task selected by the user can be accessed. Such a communication can be generated at step 750 and can comprise the return message template and interface that were received from the source at step 720. Additionally, in one embodiment, the communication generated at step 750 can further comprise an identification of the user. Also additionally, in one embodiment, the communication generated at step 750 can further comprise a return message template that the intermediate process provides in order to itself receive return messages, as well as a return message interface to which such return messages are to be provided. Subsequently, at step 760, information that a user requested that the entity, received at step 720, have a task performed upon it can be logged. Logging, at step 760, can include identification of the user, and identification of the service performing the task and the interface of that service through which such a task is accessed, as well as identification of the entity, such as the entity that was received at step 720.

Subsequently, if a return message is received, as determined by step 770, the information from that return message can be logged at step 780. As before, the logging of information received from the return message, such as at step 780, can comprise an identification of the entity on which a task was performed, an identification of the service from which the message was received and an indication of which task was performed. The logging, at step 780, to further record the entire return message itself The relevant processing can then end at step 790.

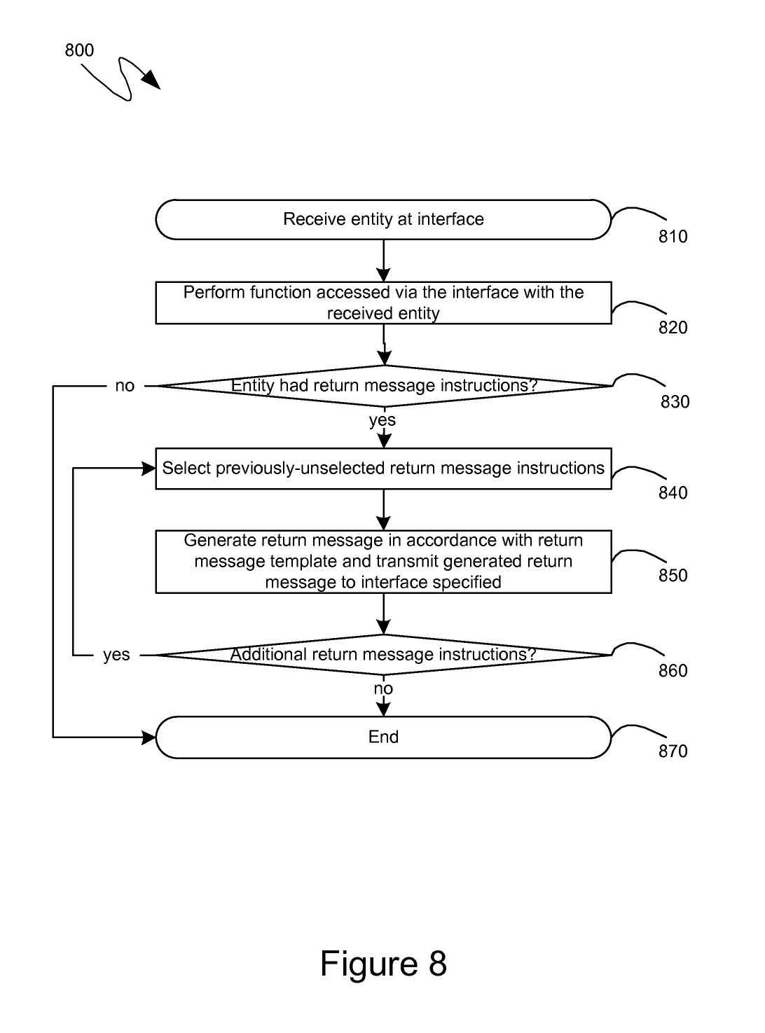

Turning to FIG. 8, the flow diagram 800 shown therein illustrates an exemplary series of steps that can be performed by a service process that can perform a task on an entity that was provided, to the service process, with return message instructions. Initially, at step 810, the service process can receive an entity at one of the interfaces that that service process makes available for accessing the functionality of that service process, such as the performance of tasks on the received entities. The receiving of the entity at an interface, at step 810, can be part of the invocation of the functionality offered by the service process through that interface and, as such, at step 820, the service process to perform the functionality, associated with that interface, on the received entity. Subsequently, at step 830, a determination can be made as to whether the entity that was received at step 810 was received with return message instructions. If, at step 830, a determination is made that there were no such return message instructions, then the relevant processing can end at step 870. Conversely, if, at step 830, a determination is made that the entity received at step 810 was received with return message instructions, then processing can proceed to step 840 where one of those return message instructions can be selected. At step 850, a return message can be generated in accordance with the return message template of the return message instructions that were selected at step 840. Additionally, at step 850, the generated return message can be transmitted to the interface that was specified in the selected return message instructions. As indicated previously, in one embodiment, at step 850, the generated return message can comprise nothing more than environmental variables such as, for example, a date/time stamp and a network address of the service process that performed the task on the entity. In another embodiment, as also indicated previously, the return message generated at step 850 can comprise an indication of the entity, such as the entity that was received at step 810, upon which the task was performed, as well as the task that was performed, preferably formatted in accordance with the return message template. At step 860, a determination can be made as to whether there were additional return message instructions associated with the entity that was received at step 810. If there were additional such return message instructions, then processing can return to step 840 and previously unselected set of return message instructions can be selected for subsequent generation of a return message to that interface at step 850. Alternatively, if, at step 860, there are no additional return message instructions, then the relevant processing can end at step 870.

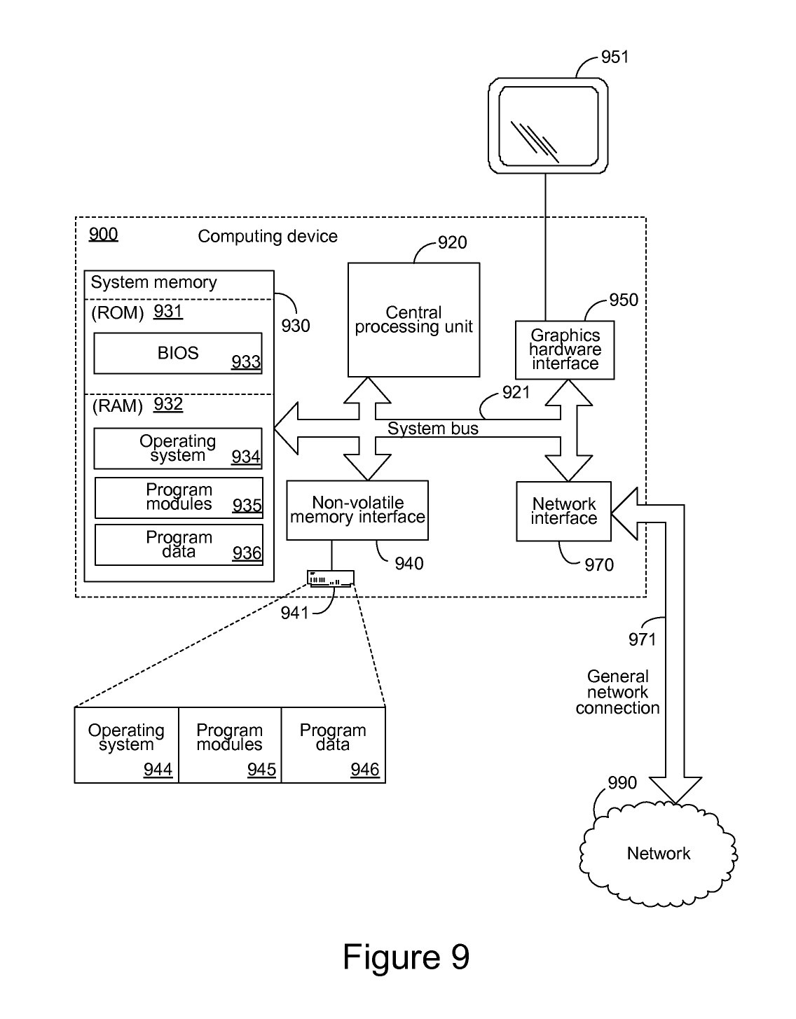

Turning to FIG. 9, an exemplary computing device 900 is illustrated. The exemplary computing device 900 can be any one or more of the client computing device 110 and the server computing devices 120, 150 and 180 illustrated in FIGS. 1 through 5, whose operations were described in detail above. For example, the computing device 900 can be a cellular telephone, personal digital assistant, tablet computing device or other like mobile computing device. Similarly, the exemplary computing device 900 can be a server computing device or a computing device that can be executing one or more processes that can represent one or more of the server computing devices 120, 150 and 180 illustrated in FIGS. 1 through 5, such as, for example, by executing one or more processes that create virtual computing environments that can provide for the operations detailed above. The exemplary computing device 900 of FIG. 9 can include, but is not limited to, one or more central processing units (CPUs) 920, a system memory 930, that can include RAM 932, and a system bus 921 that couples various system components including the system memory to the processing unit 920. The system bus 921 may be any of several types of bus structures including a memory bus or memory controller, a peripheral bus, and a local bus using any of a variety of bus architectures. The computing device 900 can optionally include graphics hardware, such as for the display of visual user interfaces, including, but not limited to, a graphics hardware interface 950 and a display device 951. Depending on the specific physical implementation, one or more of the CPUs 920, the system memory 930 and other components of the computing device 900 can be physically co-located, such as on a single chip. In such a case, some or all of the system bus 921 can be nothing more than silicon pathways within a single chip structure and its illustration in FIG. 9 can be nothing more than notational convenience for the purpose of illustration.

The computing device 900 also typically includes computer readable media, which can include any available media that can be accessed by computing device 900 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 900. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and the aforementioned RAM 932. A basic input/output system 933 (BIOS), containing the basic routines that help to transfer information between elements within computing device 900, such as during start-up, is typically stored in ROM 931. RAM 932 typically contains data and/or program modules that are immediately accessible to and/or presently being operated on by processing unit 920. By way of example, and not limitation, FIG. 9 illustrates the operating system 934 along with other program modules 935, and program data 936.

The computing device 900 may also include other removable/non-removable, volatile/nonvolatile computer storage media. By way of example only, FIG. 9 illustrates the hard disk drive 941 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940.

The drives and their associated computer storage media discussed above and illustrated in FIG. 9, provide storage of computer readable instructions, data structures, program modules and other data for the computing device 900. In FIG. 9, for example, hard disk drive 941 is illustrated as storing operating system 944, other program modules 945, and program data 946. Note that these components can either be the same as or different from operating system 934, other program modules 935 and program data 936. Operating system 944, other program modules 945 and program data 946 are given different numbers hereto illustrate that, at a minimum, they are different copies.

The computing device 900 can operate in a networked environment using logical connections to one or more remote computers. The computing device 900 is illustrated as being connected to the general network connection 971 through a network interface or adapter 970 which is, in turn, connected to the system bus 921. In a networked environment, program modules depicted relative to the computing device 900, or portions or peripherals thereof, may be stored in the memory of one or more other computing devices that are communicatively coupled to the computing device 900 through the general network connection 971. It will be appreciated that the network connections shown are exemplary and other means of establishing a communications link between computing devices may be used.

As can be seen from the above descriptions, mechanisms for returning notifications regarding the subsequent performances of tasks on entities have been enumerated. In view of the many possible variations of the subject matter described herein, we claim as our invention all such embodiments as may come within the scope of the following claims and equivalents thereto.

We claim:

1. One or more computer-readable media comprising computer-executable instructions for performing a task on an entity that is a cohesive set of information, the computer-executable instructions performing steps comprising:
performing the task on the entity;
identifying at least one set of return message instructions associated with the entity and received with the entity when the task was invoked, wherein each set of return message instructions, from among the identified at least one set of return message instructions, comprises a return message template specifying a requested format of a return message and a return interface to which the return message is to be directed;
generating the return message indicating the performance of the task on the entity; and
transmitting the generated return message to the return interface specified in the identified at least one set of return message instructions.

2. The computer-readable media of claim 1, wherein the at least one set of return message instructions comprises a first set of return message instructions provided by a source of the entity and a second set of return message instructions provided by a user agent that obtained the entity from the source of the entity and that invoked the performance of the task, the second set of return message instructions differing from the first set of return message instructions.

3. The computer-readable media of claim 1, wherein the computer-executable instructions for generating the return message comprise computer-executable instructions for generating the return message in accordance with the return message template associated with the return interface to which the generated return message will be transmitted.

4. The computer-readable media of claim 1, wherein the computer-executable instructions for generating the return message comprise computer-executable instructions for generating the return message to comprise a date/time stamp and a network address of a computing device on which the computer-executable instructions for performing the task on the entity were executed.

5. The computer-readable media of claim 1, wherein the computer-executable instructions for generating the return message comprise computer-executable instructions for generating an independent return message for each of the identified at least one set of return message instructions; and wherein further the computer-executable instructions for transmitting the generated return message comprise computer-executable instructions for transmitting, to each return interface specified in each of the identified at least one set of return message instructions, the independent return message generated for that return interface.

6. The computer-readable media of claim 1, comprising further computer-executable instructions for receiving, at an interface provided for invocation of the task, the entity and the at least one set of return message instructions associated with the entity as part of the invocation of the task.

7. One or more computer-readable media comprising computer-executable instructions for transmitting an entity that is a cohesive set of information, the computer-executable instructions performing steps comprising:
transmitting the entity to a requestor of the entity;
transmitting, with the entity, an identification of a return interface to which a return message is to be directed indicating a performance of a task on the entity; and
transmitting, with the entity, a return message template specifying a requested format of the return message.

8. The computer-readable media of claim 7, comprising further computer-executable instructions for: transmitting, with the entity, an identification of at least one interface offered by a service provider through which a performance of a task on the entity by the service provider can be invoked.

9. The computer-readable media of claim 7, comprising further computer-executable instructions for receiving the return message at the return interface.

10. The computer-readable media of claim 9, comprising further computer-executable instructions for recording, in a log, an identification of the entity and an identification of the task that was performed on the entity, as specified by the received return message.

11. The computer-readable media of claim 9, comprising further computer-executable instructions for recording the received return message in a log.

12. The computer-readable media of claim 7, wherein the identification of the return interface is an identification of an interface provided by computer-executable instructions executing on a different computing device than the computer-executable instructions for transmitting the entity.

13. A system for providing notifications to upstream processes of tasks performed on entities by downstream processes, the system comprising:
a source computing device comprising computer-executable instructions performing steps comprising: transmitting the entity to a requestor of the entity; transmitting, with the entity, an identification of a return interface to which a return message is to be directed indicating a performance of a task on the entity; and transmitting, with the entity, a return message template specifying a requested format of the return message; and
a service computing device comprising computer-executable instructions performing steps comprising: performing the task on the entity; identifying at least one set of return message instructions associated with the entity and received with the entity when the task was invoked, the identified at least one set of return message instructions comprising the identification of the return interface and the return message template; generating the return message indicating the performance of the task on the entity; and transmitting the generated return message to the return interface specified in the identified at least one set of return message instructions.

14. The system of claim 13, further comprising a user agent computing device comprising computer-executable instructions performing steps comprising: requesting the entity from the source computing device, thereby acting as the requestor; receiving the entity, the identification of the return interface and the return message template from the source computing device; receiving a user request to have the task performed on the entity;
generating a package comprising the entity, the identification of the return interface and the return message template that were received from the source computing device; and
transmitting the package to an interface exposed by the computer-executable instructions of the service computing device for accessing the performance of the task on the entity by the service computing device.

15. The system of claim 14, wherein the user agent computing device comprises further computer-executable instructions for recording, in a user agent log, an identification of the entity, an identification of the interface to which the entity was transmitted to initiate the performance of the task on the entity, and an identification of a user on whose directive the transmission was performed.

16. The system of claim 14, wherein the computer-executable instructions of the user agent computing device for generating the package comprise further computer-executable instructions for including, in the package, an identification of a user-agent return interface that differs from the return interface and a user-agent return message template that differs from the return message template.

17. The system of claim 16, wherein the user agent computing device comprises further computer-executable instructions for receiving a user agent return message at the user agent return interface; and wherein further the computer-executable instructions of the service computing device for generating the return message comprise computer-executable instructions for generating both the return message and the user agent return message; and the computer-executable instructions of the service computing device for transmitting the generated return message comprise computer-executable instructions for transmitting both the generated return message and the generated user agent return message.

18. The system of claim 17, wherein the user agent computing device comprises further computer-executable instructions for recording, in a user agent log, an identification of the entity and an identification of the task that was performed on the entity, as specified by the received user agent return message.

19. The system of claim 14, wherein the user agent computing device comprises further computer-executable instructions for registering, as being applicable to entities of a first type, the interface exposed by the computer-executable instructions of the service computing device for accessing the performance of the task on the entity by the service computing device, wherein the entity is an entity of the first type.

20. The system of claim 14, wherein the user agent computing device comprises further computer-executable instructions for presenting, to the user, potential tasks that could be performed on the entity.
